(19) United States
(12) Patent Application Publication
(10) Pub. No.: US 2017/0017133 A1
(43) Pub. Date: Jan. 19, 2017

(54) ELECTRONIC PAPER DISPLAY DEVICE

(71) Applicant: Microsoft Technology Licensing, LLC, Redmond, WA (US)

(72) Inventors: Stephen Edward Hodges, Cambridge (GB); John Franciscus Marie Helmes, Steyl (NL); Stuart Alastair Taylor, Cambridge (GB); James Scott, Cambridge (GB); Nicolas Villar, Cambridge (GB); Nicholas Yen-Cherng Chen, Cambridge (GB); David Sweeney, Cambridge (GB)

(21) Appl. No.: 14/800,224

(22) Filed: Jul. 15, 2015

(51) Int. Cl. G02F 1/167

(52) U.S. Cl. CPC G02F 1/167; G02F 2001/1676

(57) ABSTRACT

An electronic paper display device comprises a layer of multi-stable material and one or more electrodes on one face of the layer of multi-stable material. Each electrode is electrically contactable on its underside through the layer of multi-stable material so that all electrodes in the electronic paper display device are electrically contactable on a single face of the electronic paper display device.

### BACKGROUND

Electronic paper (or e-paper) is used for e-reader devices because it only requires power to change the image displayed and does not require continuous power to maintain the display in between. The electronic paper can therefore hold static images or text for long periods of time (e.g. from several minutes to several hours and even several days, months or years in some examples) without requiring significant power (e.g. without any power supply or with only minimal power consumption). There are a number of different technologies that are used to provide the display, including electrophoretic displays, electrochromic and electrowetting displays. Many types of electronic paper display are also referred to as ‘bi-stable’ displays because they use a mechanism in which a pixel can move between stable states (e.g. a black state and a white state) when powered but holds its state when power is removed.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

An electronic paper display device comprises a layer of multi-stable (e.g. electrophoretic ink) material and one or more electrodes on one face of the layer of multi-stable material. Each electrode on the face is electrically contactable on its underside through the layer of multi-stable material (e.g. through an aperture in the layer of multi-stable material) so that all electrodes in the electronic paper display device are electrically contactable on a single face of the electronic paper display device.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows schematic diagrams of various example electronic paper display devices;

FIG. 2 shows schematic diagrams of parts of contact faces of various further example electronic paper display devices;

FIG. 3 shows schematic diagrams of various example electrode arrangements;

FIG. 4 shows schematic diagrams of a routing layer which may be used in combination with the arrangements of FIGS. 1-3;

FIG. 5 shows schematic diagrams of parts of contact faces of further example electronic paper display devices;

FIG. 6 shows two further example cross-sections through an electronic paper display device;

FIG. 7 shows various arrangements of contacts in example printer devices;

FIG. 8 shows an example printer head; and

FIG. 9 is a schematic diagram of an example printer device.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

E-reader devices often use a bi-stable display because they have much lower power consumption than backlit liquid crystal displays (LCDs) or LED displays which require power to be able to display content. In contrast, a bi-stable display requires power to change state (i.e. change the image/text displayed) but does not require power to maintain a static display. However, despite the difference in display technologies used by e-reader devices, which typically employ bi-stable displays, and tablet computers, which typically employ LCDs or LED displays, the hardware architecture of e-readers and tablet computers is very similar. Both types of device contain a battery, a processor, a wired or wireless communications module and user interaction hardware (e.g. to provide a touch-sensitive screen and one or more physical controls such as buttons).

The embodiments described below are not limited to implementations that solve any or all of the disadvantages of known display devices.

Described herein is a display device which comprises an electronic paper display in the form of a multi-stable layer which is controlled (e.g. changed) using electric fields or electric currents and electrodes (which provide the electric fields/current) on one or both faces of the multi-stable layer. As described in more detail below, the electric field/current is generated by applying a voltage across electrodes which are positioned either side of the multi-stable layer and where, in some examples, one of the sets of electrodes are external to the display device. In various examples, the multi-stable layer may be an electrophoretic ink layer where the visible color of parts of the ink layer can be changed by applying electric fields to the ink layer via the electrodes. All the electrodes can be temporarily connected to separate drive circuits via a single face of the display device (referred to herein as the ‘contact face’ which may be either the front or rear face of the display) and the display device does not comprise any transistors, power supply, processor or any other electronics which traditionally form part of the backplane of a known electronic paper display device. The display device can, therefore, only be updated when transiently connected to the separate drive circuits, which may be referred to herein as a ‘printer device’.

Such a display device can be very thin and light (e.g. due to the lack of any driving electronics) and depending upon the electronic paper display technology used, can also be flexible. By providing access to all the electrodes on a single (contact) face of the device, this simplifies the printer device which is required to update the display device and where the access is provided on the front (i.e. display) face, this enables the display device to be updated when fixed to a surface (e.g. a wall) and allows a user to see what is being printed in real-time (e.g. without requiring the user to turn the display over in between printing and viewing). The display device may be of any size. For example, it may be small like a credit or business card, medium sized like an A4 sheet of paper, or much larger like a poster, noticeboard or billboard. For the larger sizes, the ability to update in situ (e.g. with a mobile printer device) makes updating much easier as the display devices may be unwieldy to handle when not fixed in place (e.g. when not fixed to a wall) and as a result may be more prone to handling damage.

There are many different applications for such a display device depending upon the particular size of the display. The smaller sized displays (e.g. up to and including A4 displays) may be used as a replacement for paper or post-it notes and the larger sized displays may be used for advertising hoardings, noticeboards, price lists, menu cards or signs which may need to be changed periodically (e.g. in shops, restaurants or other businesses) etc. and in some examples, these displays may cycle based on a set period, e.g. a week or month. Displays having higher resolution may be used to display photographs or artwork. Displays may be used as messages sent from one user to another, e.g. like a postcard, or a greeting card, or to provide reminders (e.g. in the form of a family calendar or school schedule) or for other purposes (e.g. they may be game cards or boards). Displays may be provided along with, or even built into, other products, e.g. acting as installer manuals, assembly manuals, instructions, or user guides. Although the methods described herein may be used to provide high resolution displays, in various examples the displays described herein have arrangements of electrodes which provide a low resolution (e.g. 10 dpi) or segmented display.

The term ‘electronic paper’ is used herein to refer to display technologies which reflect light (like paper) instead of emitting light like conventional LCD displays. As they are reflective, electronic paper displays do not require a significant amount of power to maintain an image on the display and so may be described as persistent displays. A multi-stable display is an example of an electronic paper display. In some display devices, an electronic paper display may be used together with light generation in order to enable a user to more easily read the display when ambient light levels are too low (e.g. when it is dark). In such examples, the light generation is used to illuminate the electronic paper display to improve its visibility rather than being part of the image display mechanism and the electronic paper does not require light to be emitted in order to function.

The term ‘multi-stable display’ is used herein to describe a display which comprises pixels that can move between two or more stable states (e.g. a black state and a white state and/or a series of grey or colored states). Bi-stable displays, which comprise pixels having two stable states, are therefore examples of multi-stable displays. A multi-stable display can be updated when powered, but holds a static image when not powered and as a result can display static images for long periods of time with minimal or no external power. Consequently, a multi-stable display may also be referred to as a ‘persistent display’ or ‘persistently stable’ display. In the examples described below the display device comprises an electrophoretic ink layer which is an example of a multi-stable layer which can be changed (or controlled) by applying electric fields. This is described by way of example and the electrophoretic ink layer may alternatively be replaced by a different multi-stable layer, such as a cholesteric liquid crystal layer or a bi-stable electrowetting display layer which is controlled using electric fields or currents applied via electrodes on the faces of the layer.

As described above, the display device may comprise electrodes on one or both faces and the connections to these electrodes are all disposed (i.e. located) on a single face referred to as the contact face, i.e. the front (display) face or the rear (non-display) face may be the contact face. In examples where the electrodes are only provided on a single face, they are provided on the non-contact face (which may be the display face or the non-display face). The connections to the electrodes may use contact pads on the single contact face which are electrically connected to the electrodes or the connections may use exposed regions of the electrodes on (or accessible from) the contact face or a combination of these may be used (e.g. with connections to the electrodes on the single face being via exposed regions of those electrodes and connections to the electrodes on the opposite face being via contact pads).

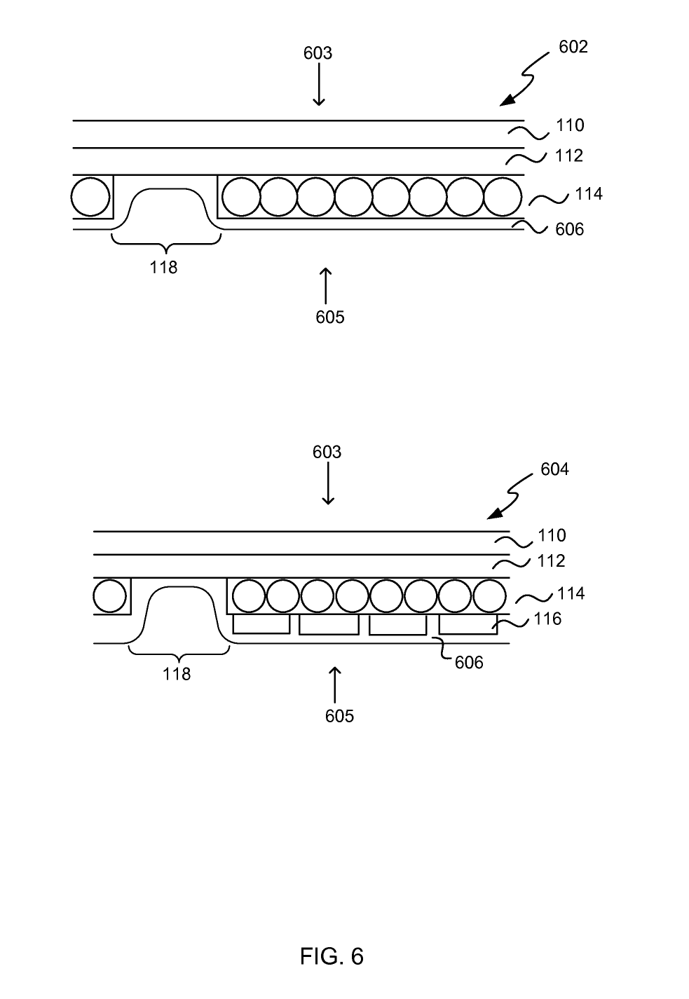

Various different examples are shown in the drawings and described below with some examples having electrodes on both faces which can be contacted via the rear (non-display) face and some examples having electrodes on both faces which can be contacted via the front (display) face. One of the examples shown in FIG. 6 only has electrodes on a single face which is not the contact face but is the face opposite the contact face (i.e. the non-contact face), where these electrodes can be contacted via the contact face and the second set of electrodes (on the contact face side of the electrophoretic ink layer) are provided as part of the printer device which is temporarily (or transiently) connected to the contact face of the display device to update the displayed content. Whilst these different examples are described separately, it will be appreciated that aspects of the examples may be combined with aspects of other examples in order to provide yet further examples.

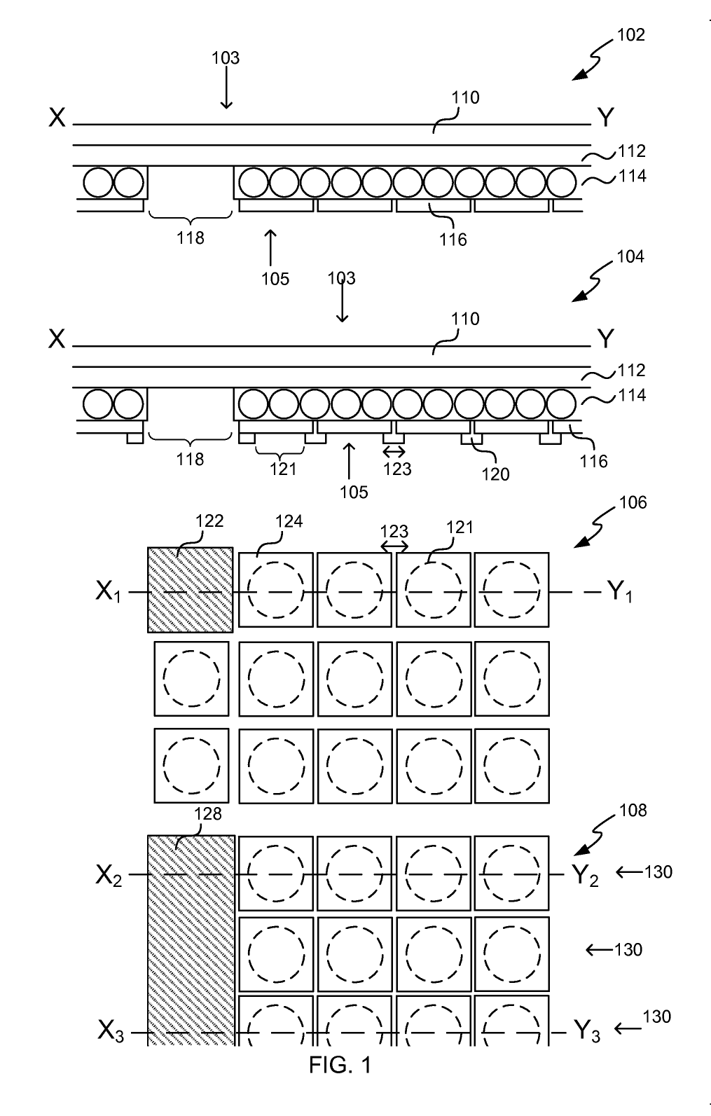

FIG. 1 shows schematic diagrams of various example electronic paper display devices. The first diagram 102 shows a cross-section through a part of an example display. The display has a front (i.e. display) face 103 and a rear (i.e. non-display) face 105 and all contacts to the electrodes are made via the rear face 105 which is therefore the contact face in this arrangement. The display comprises a layer of electrophoretic ink 114 which is sandwiched between two electrodes 112, 116 (each set comprising one or more electrodes) and by changing the potential between these two sets of electrodes, the content which is displayed can be changed.

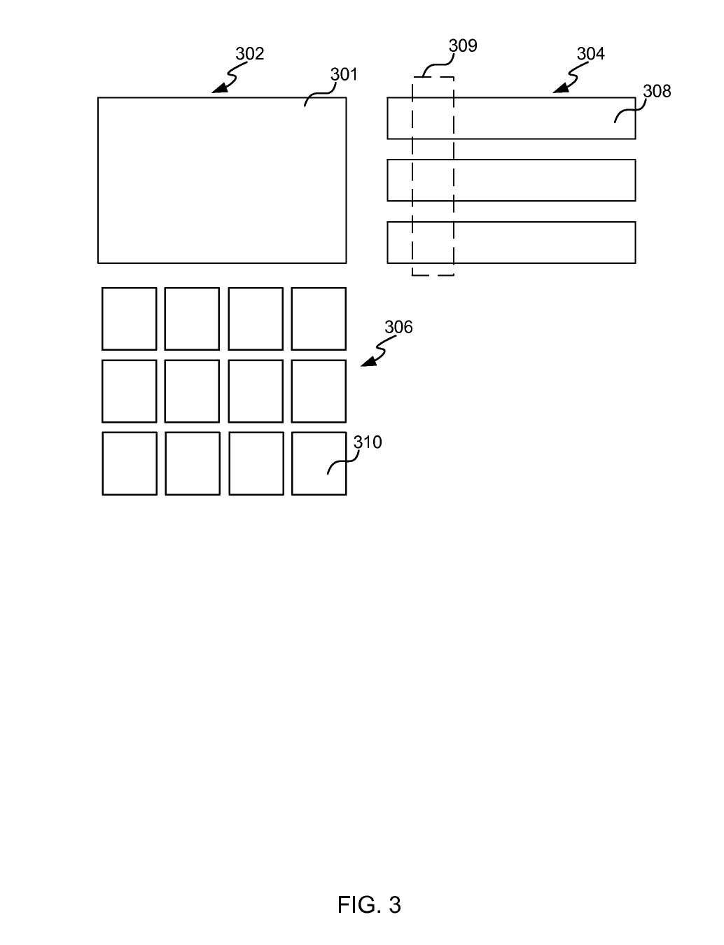

In the example shown, the front electrode 112 (i.e. the electrode which is between the electrophoretic ink layer 114 and the user when viewing the display) is a common electrode which extends across the entire display and is protected by a protective layer 110 (e.g. a plastic layer which extends across the entire display face 103), although if the front electrode 112 is robust, the protective layer 110 may be omitted in this and subsequent examples. In various examples, the front electrode 112 may be segmented (i.e. divided into two or more separate electrodes) and this is described in more detail below with reference to FIG. 3. In all the examples described herein the front electrode is formed from an optically transparent conductive material such as ITO (indium tin oxide), carbon nanotubes, graphene, FTO (fluorine doped tin oxide), a transparent semiconductor (e.g. Indium Gallium Zinc Oxide) or a transparent conducting polymer (e.g. PEDOT or PEDOT:PSS).

The rear electrodes 116 may be formed from any conductive material and need not be optically transparent, although in various examples a transparent conductive material (such as one of the examples described above) may be used. In various examples, the rear electrodes 116 may be formed in gold, copper, aluminum, etc. (which may be optically opaque or transparent dependent upon the film thickness). In other examples, the rear electrodes may be printed and so may be formed from an electrically conductive ink.

The individual pixels of the display are formed by the plurality of rear electrodes 116 as it is the potential of a rear electrode relative to the common electrode that will control the color of the display directly in front of that rear electrode. By applying different voltages to different rear electrodes 116 (with the same voltage applied to the common front electrode 112), some parts (e.g. some pixels) of the display will be black and some will be white, for a black and white display and similar principles apply where the display is a greyscale or color display.

As shown in the first diagram 102 in FIG. 1, there is a region 118 where there is no electrophoretic ink (e.g. where there is an aperture in the electrophoretic ink layer 114). This may, for example, be formed by removing a portion of the electrophoretic ink (e.g. using a chemical and/or abrasion) or by applying a patterned electrophoretic ink layer. Although all the examples shown in the examples have an aperture which has part of the electrophoretic ink layer to the left and right of the aperture (in the orientation shown in the diagrams), it will be appreciated that the aperture may be at one edge of the electrophoretic ink layer such that it is only present on one side (e.g. left or right) of the aperture. Electrical contact can be made to the front electrode 112 from the rear face 105 (which is the contact face in this example) through the aperture 118 and contact can be made to the rear electrodes 116 from the rear face 105 as, in this example, the rear electrodes 116 are completely exposed.

The second diagram 104 in FIG. 1 shows a cross-section through a part of a second example display. This example differs to that shown in the first diagram 102 (and described above) in that it additionally comprises a non-conductive mask layer 120 on the rear face 105. As shown in FIG. 1, the non-conductive mask layer 120 comprises a plurality of apertures 121 (e.g. one aperture 121 per electrode 116) such that a portion of each rear electrode 116 is exposed so that electrical contact can be made to each rear electrode 116. In various examples (e.g. where the electrodes 116 are printed using conductive ink), the non-conductive mask layer 120 may be printed onto the display device and may comprise non-conductive ink.

The non-conductive mask layer 120 protects the electrodes 116 on the contact face against damage (e.g. handling damage) and also reduces (or eliminates) the possibility that a contact on a printer device contacts against two rear electrodes 116 at the same time. This may be achieved by ensuring that the pitch and size of the apertures 121 is such that a contact on the printer device, even when totally misaligned, is not large enough to bridge the portion of the mask layer 120 between two apertures 121, i.e. the separation between apertures (as indicated by arrow 123 in FIG. 1) must be larger than the width of the printer device contacts (or the ends of the printer device contacts where these have the form of tapering pins, bumps or other protrusions). Whilst this same function (i.e. the avoidance of shorting of electrodes) could be achieved by introducing larger gaps between the electrodes themselves (e.g. such that the separation of rear electrodes is larger than the width of the printer device contacts) this would result in gaps between the pixels in the display device (e.g. as there would be parts of the electrophoretic ink layer 114 that do not experience sufficient electrical fields to change state) and may degrade the overall visual appearance of the display device.

The third diagram 106 in FIG. 1 is a schematic diagram of a contact face (e.g. the rear face 105) of an electronic paper display device and which in cross-section along the dotted line X₁-Y₁ may resemble that shown in diagram 102 (without the non-conductive mask layer 120) or diagram 104 (with the non-conductive mask layer 120). As shown in this third diagram 106, there are a plurality of electrodes 124 which in the example shown are square in shape and arranged in a regular grid/array. In other examples, however, the electrodes 124 may be of different shapes and/or arranged in any way (e.g. in an irregular pattern). Where a non-conductive mask layer 120 is used, the apertures 121 in this mask layer are shown as dotted circles in FIG. 1 and the separation of apertures is indicated by arrow 123. As shown in FIG. 1, one of the cells in the grid/array does not contain an electrode 124 but instead is the contact 122 to the common electrode (e.g. front electrode 112) on the opposite face of the display device (i.e. the face opposite the contact face). As shown in the first two diagrams 102-104, this contact 122 may be an exposed portion of the common electrode which is accessible from the contact face through an aperture 118 in the electrophoretic ink layer 114. Alternatively, the aperture may be coated to provide a contact which is electrically connected to the common electrode through the aperture.

The fourth diagram 108 in FIG. 1 is a schematic diagram of a contact face (e.g. the rear face 105) of another example electronic paper display device and which in cross-section along the dotted line X₂-Y₂ may resemble that shown in diagram 102 (without the non-conductive mask layer 120) or diagram 104 (with the non-conductive mask layer 120). This example differs from that shown in the third example 106 in that the contact 128 to the electrode on the other face is extended in one direction such that the cross-section along dotted line X₃-Y₃ is the same as at dotted line X₂-Y₂. This means that a printer device can contact the electrode at many different positions on the contact face of the display device and if the printer device comprises a single row of contacts (e.g. oriented parallel to line X₂-Y₂ in the diagram) it will always be able to contact an electrode on the opposite face irrespective of which row 130 of electrodes 124 it is aligned with. This is not true of the example shown in the third diagram 106 because there is only a single position (contact 122) on the contact face where a printer device can electrically connect to an electrode on the opposite face.

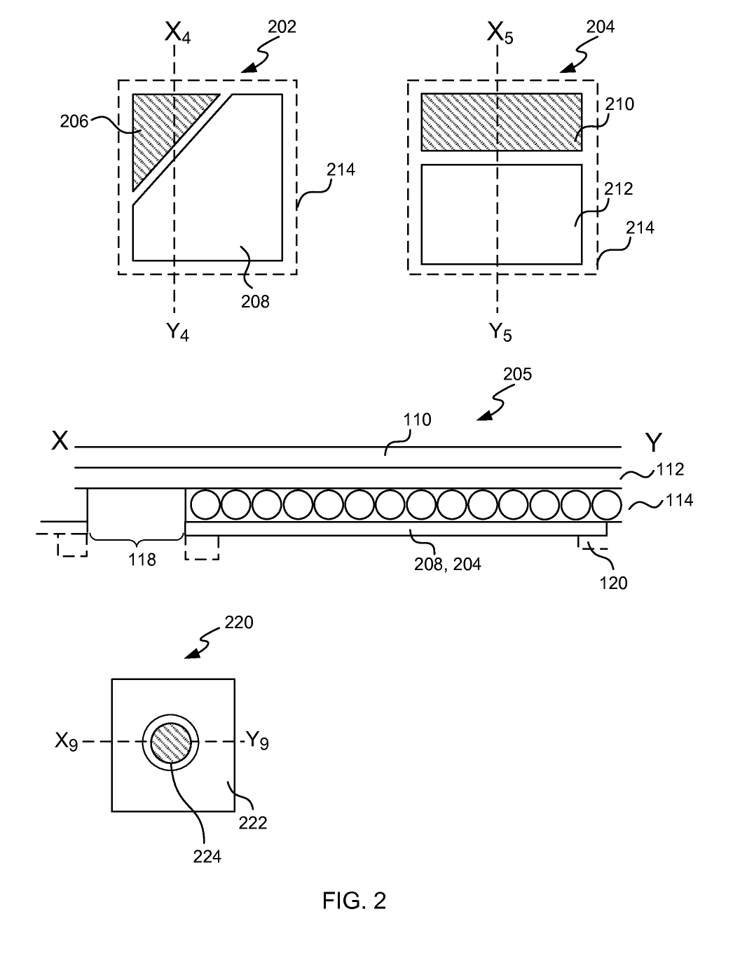

The first two diagrams 202, 204 in FIG. 2 show schematic diagrams of parts of contact faces (e.g. rear faces 105) of two further example electronic paper display devices. Each of these diagrams 202, 204 show a single electrode 208, 212 on the contact face (e.g. which corresponds to a single electrode 124 in the third and fourth examples 106, 108 in FIG. 1). In both these examples, there is one contact 206, 210 for an electrode on the opposite face (e.g. the front face 103) adjacent to each electrode 208, 212 on the contact (e.g. rear) face (e.g. one contact 206, 210 to the opposite electrode per pixel, where a pixel is defined by the electrode 208, 212 on the face shown in FIG. 2). As shown in the example cross-section 205 (along dotted line X₄-Y₄ or X₅-Y₅) the contact through the display from the contact face to the electrode 112 on the opposite face may be provided by an aperture 118 in the electrophoretic ink layer 114. As described above, a non-conductive mask layer 120 may be used in various examples.

By using the arrangement shown in FIG. 2 with contacts to electrodes on both sides of the electrophoretic ink layer 114 being adjacent to each other and provided for each pixel, a printer device can contact the electrode at any position on the contact face of the display device and may, in various examples, write a single pixel at a time e.g. where the printer device comprises only two contacts, one which contacts the electrode on the contact face and one which contacts the electrode on the opposite face. As described in more detail below, a printer device may use a camera or other vision system to align the contacts (e.g. protrusions) on the printer device to the contacts on the contact face of the display device and/or to only apply a voltage when correctly aligned (e.g. to avoid a situation where the two contacts on the printer device are not both in contact with contacts for the same pixel).

The apertures 118 in the electrophoretic ink layer 114 which are adjacent to each electrode 208, 212 (e.g. adjacent to each pixel) in the examples shown in FIG. 2 may result in a visible gap between pixels in the display and this gap may be less visible in the configuration shown in the first example 202 compared to the second example 204. A further example configuration is shown in the final example 220 in FIG. 2. In this example, the electrode 222 on the contact face is square with a hole at the center and the aperture 118 in the electrophoretic ink layer which exposes the contact 224 on the opposite (non-contact) face is within the hole in the electrode 222. Furthermore, for larger displays, which are viewed from greater distances, these gaps may not visibly impair the quality of the display.

Depending upon the arrangement of the apertures (which may also be referred to as vias) through the electrophoretic ink layer 114, the electrode on the non-contact side of the display (e.g. the front electrode 112 in the examples described above) may be a single electrode 301 which extends across the entire display as shown in the first example 302 in FIG. 3. Use of a single electrode 301 on the non-contact face (i.e. the face which is opposite the face via which contact to the electrodes is made) is compatible with any of the arrangements of apertures shown in FIGS. 1 and 2. In various examples there may be only a single aperture (and hence connection point) to the single electrode 301 and in other examples there may be multiple apertures providing multiple connection points to the single electrode 301 (e.g. with apertures spaced regularly in one or two dimensions).

In various examples, the electrode on the non-contact side may comprise a plurality of electrode strips 308 as shown in the second example 304 in FIG. 3. This arrangement of electrodes on the non-contact face is compatible with the arrangements of apertures shown in diagram 108 in FIG. 1 and in FIG. 2. Referring to the arrangement shown in diagram 108 in FIG. 1, the elongated aperture/contact 128 through the electrophoretic ink layer 114 is arranged so that it exposes a part of each of the electrode strips 308, e.g. as shown by the dotted rectangle 309 in FIG. 3. Whilst the aperture/contact 128 is shown perpendicular to the electrode strips 308, this is by way of example only and the aperture/contact 128 may intersect with the strips 308 at any angle.

In further examples, the electrode on the non-contact side of the display device may comprise a plurality of electrode elements 310 which may be arranged in a regular grid/array (as in the third example 306 in FIG. 3) or in an irregular pattern. This arrangement of electrodes on the non-contact face is compatible with the arrangement of apertures shown in FIG. 2 and the electrode elements 310 may be aligned with the electrode 208, 212 and aperture 206, 210 pairs, e.g. each electrode element 310 may be aligned with the ‘pixel outline’ shown by a dotted square 214 in FIG. 2. Alternatively, each electrode element 310 may cover multiple pixels, such that whilst some alignment between the pixel electrodes on the contact face and the larger electrode element 310 on the non-contact face may be required, it need not be a one-to-one mapping between contact face and non-contact face electrodes.

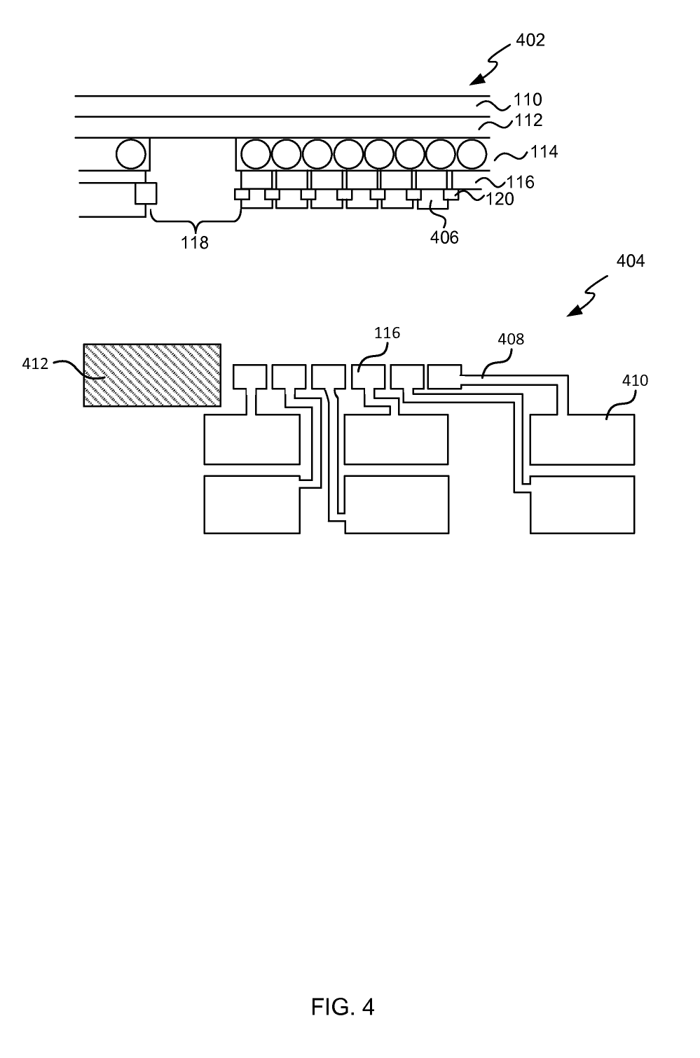

In the examples shown in FIGS. 1 and 2, contact is made, on the contact face, directly to the electrodes on the contact face of the display device (e.g. to the rear electrodes 116 in the examples shown) and to the electrode(s) on the opposite (non-contact) face through apertures 118 through the electrophoretic ink layer 114. In other examples, however, the display device may further comprise a patterned routing layer 406 on the contact face as can be described with reference to FIG. 4 which shows both a cross-section 402 and a schematic diagram of the contact face 404. The routing layer 406 provides one or more conductive tracks (or traces) 408 which each extend from an electrode 116 to a contact pad 410. A contact pad 410 may be larger than an electrode 116 and/or may be a different shape and/or orientation and in the example is separated laterally (within the plane of the contact face) from the electrode 116. The routing layer 406 therefore enables the arrangement of the contacts on the printer device (which must align to the contact pads 410) to be different to the arrangement of the electrodes and this may, for example, enable larger contacts on the printer device and/or more spatially separated contacts on the printer device. In various examples, the electrodes 116, traces 408 and contact pad 410 may be formed from the same material at the same time and in other examples, the traces 408 and contact pad 410 may be formed separately and subsequently to the electrodes 116.

In the example shown in FIG. 4, the routing layer 406 is not used to re-position the contact 412 for the electrode on the opposite face of the display device (i.e. the electrode on the non-contact side of the display) but in other examples, the routing layer may also be used for this contact.

In the examples described above, the contact face is the rear face of the display device. In other examples, however, the contact face may be the front face of the display device. The arrangements shown in FIGS. 1 and 2 may also be used where the contact face is the front face and in such examples, face 105 is now the front (display) face, which is the contact face, and face 103 is the rear (non-display) face.

In this reverse configuration of the examples shown in FIG. 1 and described above, the plurality of electrodes 116 are now front electrodes (i.e. the electrodes are positioned between the electrophoretic ink layer 114 and the user when viewing the display) and are formed from an optically transparent conductive material such as ITO (indium tin oxide), carbon nanotubes, FTO (fluorine doped tin oxide) or a transparent conducting polymer (e.g. PEDOT or PEDOT:PSS). The electrode 112 is now the rear electrode and so may be formed from any conductive material and need not be optically transparent (e.g. it may be formed in gold, copper, aluminum, an electrically conductive ink, etc.). In these configurations, the electrode 112 may be a single electrode 301 (as in example 302 in FIG. 3) or comprise a plurality of electrode strips 308 (as in example 304 in FIG. 3).

Similarly, in the reverse configuration of the examples shown in FIG. 2 and described above, the plurality of electrodes 208, 212 are now front electrodes and are formed form an optically transparent conductive material and the electrode 112 (which may have any of the configurations shown in FIG. 3) is now the rear electrode and need not be optically transparent.

As shown in FIGS. 1 and 2 and described above, the electrodes 116, 208, 212, 222 (which are now front electrodes) may be entirely exposed (e.g. as shown in diagram 102 and diagram 205 without the dotted layer 120) or partially protected using the non-conductive mask layer 120 (e.g. as shown in diagram 104 and diagram 205 with the dotted layer 120) where, in this configuration, the mask layer 120 also needs to be optically transparent if it is not to obscure part of each pixel. As described above, the effect of using an opaque mask material may be less noticeable to a viewer for larger display devices where the display is viewed from a distance and more noticeable for smaller displays (e.g. those that may be held in the hand) where the viewing distance is short (e.g. <1 m).

If the electrodes 116 are formed from a transparent conductive polymer (e.g. rather than graphene or carbon nanotubes), this may provide a more fragile layer than in the originally described configuration of FIG. 1, where the electrodes may be formed from a metal or conductive ink and do not need to be optically transparent. As a result, the apertures 121 in the mask layer 120 may be small (e.g. 0.05-0.10 mm in diameter for 200 dpi, 0.5-1.0 mm in diameter for 20 dpi or scaled accordingly for different pixel sizes) to reduce the likelihood of damage (e.g. handling damage or wear caused by repeated contact with a printer device) and/or the contacts on the printer device may be configured to minimize damage (e.g. they may be made compliant in some way). Where the apertures 121 are small, this may necessitate use of an optically transparent material for the mask layer as otherwise the visual effect of the display may be significantly degraded.

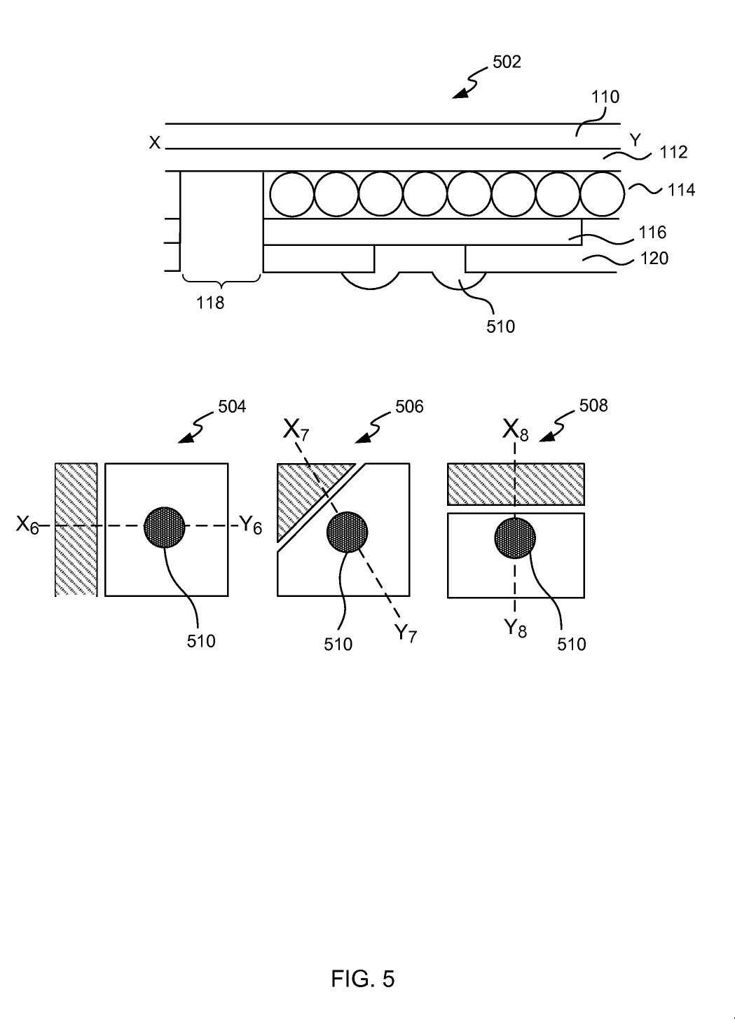

FIG. 5 shows an alternative arrangement where the optically transparent front electrodes 116 are completely covered by other materials to protect them from damage. FIG. 5 shows a cross-section 502 which is similar to that shown in FIG. 1 but with the difference that the aperture 121 in the mask layer 120 is filled by a material which provides an electrical contact 510 on the contact face. The electrical contact 510 may, for example, be positioned at, or close to, the center of each electrode 116 (and hence each pixel) and be formed from an optically-opaque but electrically conductive material (e.g. a metal or conductive ink) which is more robust than the material forming the electrode 116 itself. If the electrical contact 510 is small (compared to the size of the pixel) it may not significantly impair the visual effect of the display, particularly for larger displays.

The electrical contact 510 may be used in configurations where the other electrode 112 is a single electrode 301 or comprises a plurality of electrode strips 308 and where the contact to this other (rear) electrode is per display (as in diagram 106), per row of pixels (as in diagram 108) or per pixel (as in diagrams 202, 204). Further examples are shown in FIG. 5 where diagram 504 is a schematic diagram of the contact face of a display for a per-display or per-row configuration and diagrams 506, 508 correspond to diagrams 202, 204 with the addition of the electrical contact 510. Each of these diagrams 504, 506, 508 has a dotted line Xᵢ-Yᵢ (where i=[6,7,8]) showing how the diagram relates to the cross-section 502.

All the examples described above comprise electrodes on both sides of the electrophoretic ink layer 114, i.e. both front and rear electrodes, irrespective of whether the front or rear face is the contact face. In various examples, however, electrodes may only be provided on the face of the electrophoretic ink layer 114 which is opposite the contact face (i.e. electrodes are provided on the non-contact side of the ink layer 114 and not on the contact face). This is shown in the first cross-section 602 in FIG. 6. Comparing this cross-section to cross-sections 102 and 205, it can be seen that the electrodes 116, 208, 212 on the contact face 605 have been omitted and instead these electrodes are provided as part of the printer device. In this example, either face 603 or face 605 may be the front (display) face of the electronic paper display device.

As shown in FIG. 6, a thin protective layer 606 may be provided to protect the electrophoretic ink layer 114 from damage due to handling or wear from repeated contact with printer devices. In the examples shown in FIG. 6, this protective layer 606 covers the aperture 118 in the electrophoretic ink layer; however, in other examples, there may be an aperture in the thin protective layer 606 which is aligned to the aperture 118 in the electrophoretic ink layer. This enables a direct, galvanic connection to the electrode 112 on the non-contact face (i.e. through the apertures in both the electrophoretic ink layer 114 and the protective layer 606). The protective layer, where provided, may be an insulating (i.e. non-conductive) film or alternatively it may be an anisotropic conductive film (ACF) which allows electrical interconnection through the film but is electrically insulating in the plane of the film. In examples where the protective layer 606 is insulating, the electric field which controls the state of the elements within the electrophoretic ink layer 114 is generated between the electrodes 112 on the non-contact face and the electrodes in the printer and passes through the protective layer 606. Higher voltages may be used to generate the electric field compared to the examples shown in FIGS. 1, 2, 4 and 5 because of the increased separation between the electrodes due to the protective layer 606.

The second cross-section 604 in FIG. 6 shows an electronic paper display device which, like the examples shown in FIGS. 1, 2, 4 and 5, has electrodes on both sides of the electrophoretic ink layer 114; however, unlike the earlier examples described above, in the example shown in cross-section 604, the electrodes on the contact face 605 are not exposed and are instead entirely covered by a protective layer 606. The protective layer 606 protects the underlying structure (e.g. electrodes 116) from damage due to handling or wear from repeated contact with printer devices and as described above it may be an insulating film or an ACF. Where ACF is used, it allows electrical interconnection between contacts on the printer device and the electrodes 116 on the contact face (but does not create short circuits between electrodes because it is electrically insulating within the plane of the film). Alternatively, where an insulating film is used the electrodes act as conduits for the electric field.

The examples shown in FIG. 6 may be implemented with any of the configurations shown in FIG. 3, e.g. with a single electrode 112 on the non-contact face 603 (as in example 301 in FIG. 3) and one or more apertures 118 through the electrophoretic ink layer 114 (and in some examples also through the protective layer 606) or with more than one electrode 112 on the non-contact face 603 (as shown in examples 302, 303 in FIG. 3) and at least one aperture 118 through the electrophoretic ink layer 114 (and in some examples also through the protective layer 606) for each electrode 112.

The description above relates primarily to the electronic paper display device. In order to update the content displayed on the display device, it is necessary to bring the display device temporarily into contact or very close proximity with a printer device. In various examples, the printer device comprises a plurality of contacts (e.g. protrusions or electrodes) which may either electrically connect to the electrodes on the contact face of the display device (e.g. as in all the examples described above except for 602) or be the contact face electrodes (e.g. as in example 602). In other examples, however, the printer device may generate the electric field through interference. Where interference is used, the printer device need not comprise a plurality of discrete contacts (as in the previously described examples); however, in many examples the printer may still comprise a plurality of contacts, and the electric field generated may be more detailed than the discrete electrical contacts would allow if they were galvanic connections. Use of interference patterns to generate the electric field may enable generation of smooth, resolution agnostic, images.

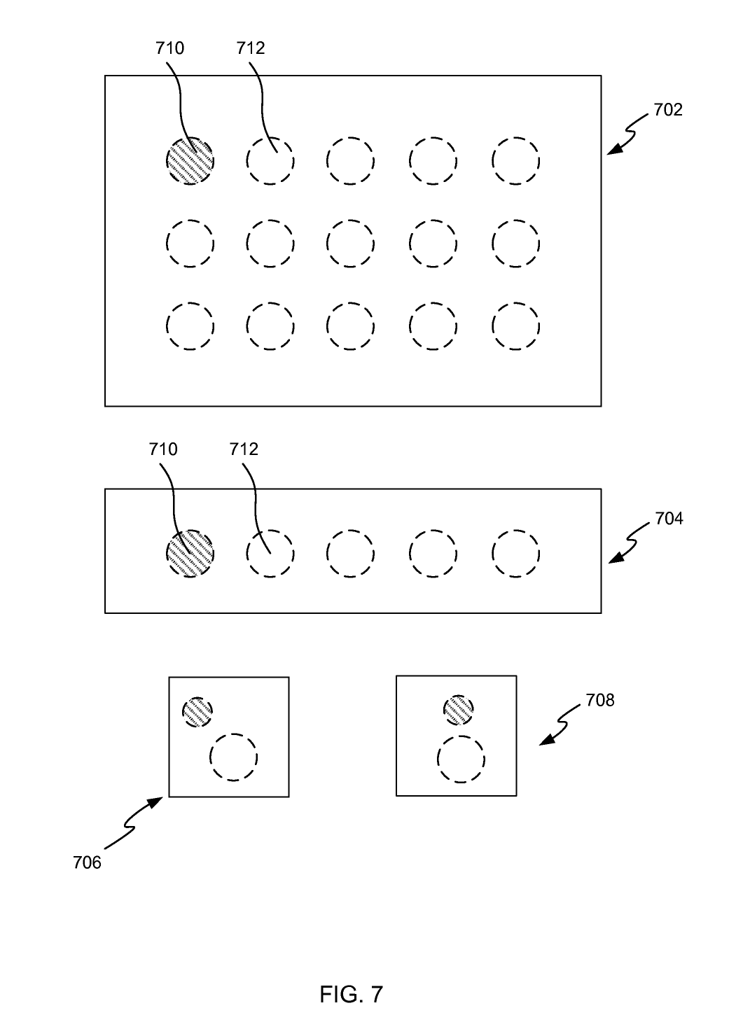

The arrangement of contacts on the printer device depends, at least in part, on the arrangement of electrodes 112, 116 and apertures 118 in the electrophoretic ink layer 114 in the display device as to be able to change the state of the electrophoretic ink layer, the printer must set up a large enough electric field across the electrophoretic ink layer by connecting to electrodes in the electronic paper display device. Where there is a single electrode 112 on the non-contact face and a single aperture 118 through electrophoretic ink layer 114, the printer device may comprise an array of contacts where a single contact 710 connects to the electrode 112 on the non-contact face and the remaining contacts 712 connect to the electrodes 116 on the contact face, as shown in the first example 702 in FIG. 7. In this example, the printer device contacts all the contacts 710, 712 at the same time. In other examples, however, the printer device may not contact all the electrodes on the display device at the same time (e.g. the printer device may have fewer contacts than there are electrodes on the display device) and in such examples, relative motion between the printer device and the display device is used to address all the electrodes on the display device. In various examples a user may move the printer device relative to the display device (where the user may move either or both of the printer device and the display device) and in other examples, the printer device may include a feed/motion mechanism (as described in more detail below).

In examples where there is an aperture 118 through the electrophoretic ink layer 114 in each row of electrodes 130 (e.g. a separate aperture in each row or an elongate aperture 128 as shown in example 108 in FIG. 1), the printer device may comprise a single row of contacts comprising a contact 710 arranged to connect with the electrode 112 on the non-contact face (through an aperture 118 in the electrophoretic ink layer 114) and a plurality of contacts 710 arranged to connect with the electrodes 116 on the contact face, as shown in the second example 704 in FIG. 7. In this example relative motion between the printer device and the display device may be used to address all the electrodes on the display device.

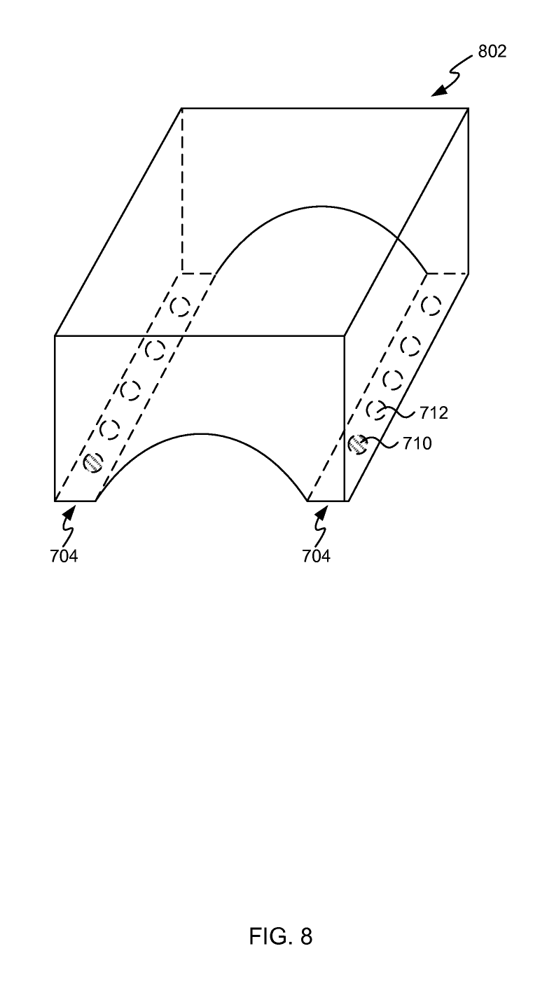

In various examples the printer device may comprise a plurality of rows of contacts, where these rows may correspond to adjacent rows of electrodes on the electronic paper display device or non-adjacent rows of electrodes and an example of such a printer head 802 is shown in FIG. 8. If the separation of the two rows 704 is X rows, the printer head 802 updates pixels in rows r and r+X at the same time and then steps to update rows r+1 and r+1+X, etc. Every X updates, the printer may step by X+1 rows (instead of by 1 row) in order that all the rows are updated efficiently (e.g. without updating some rows more than once before all the rows have been updated). In other examples, the printer head may comprise Y adjacent rows and may step by Y rows after each update operation.

In examples where there is an aperture through the electrophoretic ink layer 114 for each pixel (e.g. as shown in FIG. 2), the printer device may comprise one or more pairs of contacts for each pixel where one contact in each pair is arranged to connect with the electrode 112 on the non-contact face (through an aperture 206, 210 in the electrophoretic ink layer 114) and the other contact in each pair is arranged to connect with the electrodes 208, 212 on the contact face. The third and fourth examples 706, 708 in FIG. 7 show example contact pairs corresponding to the two arrangements shown in FIG. 2. In an example where a printer device comprises a single pair of contacts, this enables the printer device to update the pixels in the electronic paper display device in any order. Where the printer comprises more than one pair of contacts, these may correspond to adjacent pixels or non-adjacent pixels in the electronic paper display device. In this example relative motion between the printer device and the display device may be used to address different electrodes on the display device.

The printer device may comprise a vision system which is used to align the printer contacts and the electronic paper display device (e.g. where the printer device comprises a feed/motion mechanism) and/or to only apply voltages to the printer contacts when the electronic paper display device is correctly aligned with the electronic paper display device (e.g. where the user moves the printer device relative to the display device). The vision system may utilize the shapes of the electrodes on the display device and/or visual features may be provided on the display device specifically for the vision system to track. These features may, in various examples, be invisible to a human (e.g. they may be visible under IR illumination). In various examples, the vision system may use a previous print as the registration features for the vision system in addition to, or instead of, using the shape of the contacts or dedicated reference features. The vision system may use optical vision (e.g. a camera) and/or the vision system may use electrical/capacitive/magnetic sensing.

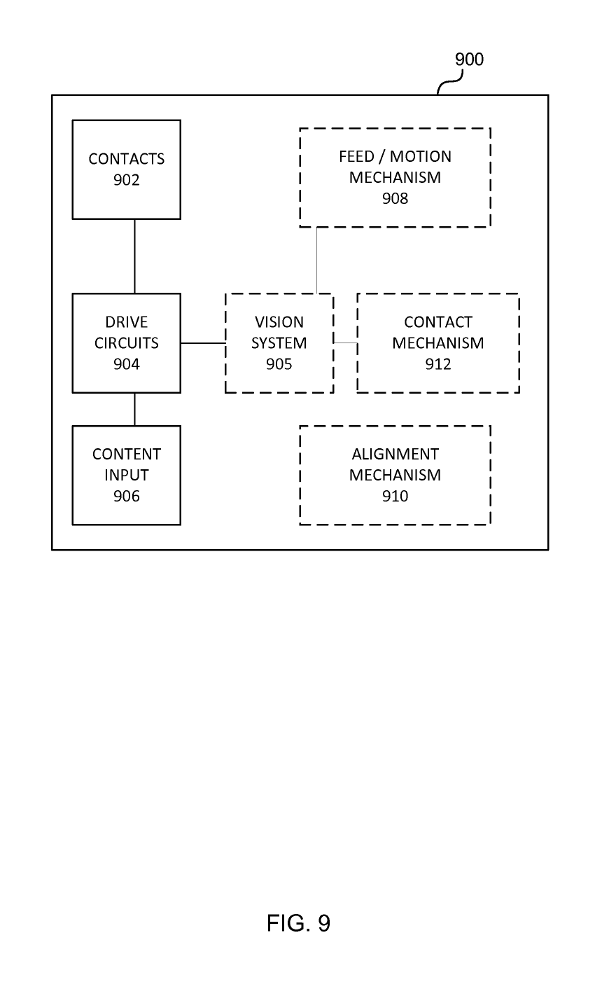

FIG. 9 is a schematic diagram of a printer device 900 which comprises a plurality of contacts 902 as described above with reference to FIGS. 7 and 8. The printer 900 also comprises drive circuits 904 (e.g. comprising a plurality of transistors to drive the electrodes and hence change the electric field across the electrophoretic ink layer 114) which is connected to the contacts 902 and as described above, a vision system 905 may be provided to control when voltages are applied by the drive circuits 904 to the contacts 902 (and hence to a temporarily connected electronic paper display device). The printer 900 further comprises a content input 906 arranged to receive content data which defines what is to be displayed on a temporarily connected electronic paper display device and hence the voltages to be applied to the contacts 902 by the drive circuits 904.

Depending upon the particular arrangement of the printer device 900, it may further comprise a feed or motion mechanism 908 which is arranged to either move the electronic paper into position relative to the contacts 902 or to move the contacts 902 relative to the temporarily connected electronic paper display device (e.g. a feed/motion mechanism 908 may be provided where there are fewer contacts on the printer device than electrodes on the display device). The motion may be in one direction (e.g. a linear feed mechanism) or in two directions. In various examples, the motion mechanism 908 may move the contacts 902 in a non-linear motion relative to the temporarily connected electronic paper display device relative and this may, for example, enable random updating of pixels on the temporarily connected electronic paper display device. In various examples, the configuration of the electrodes and contacts may be arranged to maximize the length of time that the electrodes and contacts are in contact during the motion (e.g. through the use of elongated contacts/electrodes) in order to maximize the time for which the voltage and resulting electric field (or electric current, depending on the type of multi-stable display) is applied.

In examples where a feed/motion mechanism 908 is not included, the printer device 900 may comprise an alignment mechanism 910 which controls the relative position of the printer device and the display device. The alignment mechanism 910 may, for example, comprise mechanical alignment features against which an edge or corner (or multiple edges/corners) of the display device can be located.

The printer device 900 may also comprise a contact mechanism 912 which brings the contacts 902 of the printer device 900 into contact or close proximity with the electrodes on the display device. The contact mechanism 912 may, for example, apply pressure to the contact and/or non-contact side of the display, e.g. in the form of a mechanical force along the edges or a force across the entire display surface. In various examples, a vacuum, magnetic force or lightly adhesive surface may be used.

Whilst FIG. 9 shows some possible connections between the elements 902-912 within the printer device 900 it will be appreciated that these are shown by way of example only and in variations of the printer device 900, one or more of these connections may be omitted and/or one or more additional connections may be provided.

As described above, because all the contacts on the electronic paper display device are accessible from a single face of the display device, the printer only needs to have electrical contacts with one face and this reduces the complexity of the printer device compared to an arrangement requiring electrical contact with both faces of the display device. Also, where the display device is flexible (as enabled by the lack of any drive electronics), this enables a compact feed mechanism which may roll the display device around and between rollers in an analogous manner to a traditional paper printer.

As described above, the electronic paper display device described herein may, in various examples, provide a large form factor, wall-mounted display. In various examples, the printer may be mounted within the wall (i.e. behind the display device such that it can move up and down and update parts of the display device), on the wall (i.e. in front of the display device such that it can move up and down and update parts of the display device) or may be mobile/removable such that is it only offered up to the display device when updates are required. In various examples, where there is a single electrode on the non-contact face, contact to this electrode may be via a flying lead (connected through a via in the electrophoretic ink layer) and the contacts on the printer may only connect to electrodes on the contact face.

Although the present examples are described and illustrated herein as being implemented in a display device system comprising an electrophoretic ink layer, the system described is provided as an example and not a limitation. As those skilled in the art will appreciate, the present examples are suitable for application in a variety of different types of display devices which may use other types of multi-stable display layers which can be controlled (e.g. their visual appearance can be changed) using an electric field or an electric current (although the configuration shown in the second cross-section 604 in FIG. 6 will not work for electric currents).

A first further example provides an electronic paper display device comprising: a layer of multi-stable material, wherein a visual appearance of the multi-stable material is controllable by application of an electric field or electric current; and a first set of electrodes on a first face of the layer of multi-stable material, the first set of electrodes comprising one or more electrodes, and wherein the electrodes in the first set of electrodes are electrically contactable on a single face of the electronic paper display device through the layer of multi-stable material.

A second further example provides an electronic paper display device comprising: a layer of multi-stable material; and a first set of electrodes on a first face of the layer of multi-stable material, the first set of electrodes comprising one or more electrodes, wherein a visual appearance of the multi-stable material is controllable by application of a voltage between the first set of electrodes and a second set of electrodes, and wherein the electrodes in the first set of electrodes are electrically contactable on a single face of the electronic paper display device through the layer of multi-stable material.

In the first and second further examples, the layer of multi-stable material may be a layer of electrophoretic ink material.

In the first and second further examples, the electrodes in the first set of electrodes may be electrically contactable on a single face of the electronic paper display device through one or more apertures in the layer of multi-stable material.

A third further example provides an electronic paper display device comprising: a layer of electrophoretic ink material; and a first set of electrodes on a first face of the electrophoretic ink layer, the first set of electrodes comprising one or more electrodes, and wherein the electrodes in the first set of electrodes are electrically contactable on a single face of the electronic paper display device through one or more apertures in the electrophoretic ink layer.

In any of the first to third further examples, the first set of electrodes may comprise a single electrode and there may be a single aperture through the layer of multi-stable material.

In any of the first to third further examples, the first set of electrodes may comprise a plurality of electrodes and there is one aperture through the layer of multi-stable material for each electrode in the first set of electrodes.

Any of the first to third further examples may further comprise: a second set of electrodes on a second face of the layer of multi-stable material, the second set of electrodes comprising one or more electrodes, and wherein the electrodes in both the first and the second sets of electrodes are electrically contactable on a single face of the electronic paper display device.

Any of the first to third further examples may further comprise: a non-conductive masking layer covering the second set of electrodes and comprising openings which expose a portion of each of the electrodes in the second set. The openings may be smaller than the electrodes such that each electrode in the second set of electrodes is partially covered by the non-conductive masking layer and partially exposed.

Any of the first to third further examples may further comprise: a plurality of routing tracks formed in a conductive layer over the non-conductive masking layer and arranged to electrically connect an electrode in the second set to a contact pad formed in the conductive layer.

Any of the first to third further examples may comprise: a display face and a non-display face, wherein the single face is the display face and wherein the electrodes in the second set of electrodes are formed from an optically transparent and electrically conductive material. The display device may further comprise: an optically transparent and non-conductive masking layer covering the second set of electrodes and comprising openings which expose a portion of each of the electrodes in the second set; and a plurality of optically opaque and conductive regions covering each exposed portion of the electrodes in the second set. The second set of electrodes may comprise a plurality of electrodes formed from an optically transparent and electrically conductive polymer.

The second set of electrodes may comprise a plurality of electrodes arranged in rows and wherein the electrodes in the first set of electrodes are electrically contactable on a single face of the electronic paper display device through a plurality of apertures in the layer of multi-stable material, one aperture being adjacent to each row of electrodes from the second set.

Any of the first to third further examples may comprise: a display face and a non-display face, wherein the single face is the non-display face and wherein the electrodes in the first set of electrodes are formed from an optically transparent and electrically conductive material.

Any of the first to third further examples may be arranged to provide a low resolution, large form-factor wall-mounted display.

A fourth further example provides a printer device arranged to update an electronic paper display device when temporarily connected to the printer device, the printer device comprising: a first set of contacts comprising one or more contacts arranged to connect to a first set of electrodes on a non-proximate face of the electronic paper display device through apertures through a layer of multi-stable material in the electronic paper display device; a second set of contacts, in a same plane as the first set of contacts, and comprising one or more contacts; and drive circuits connected to the first and second set of contacts and arranged to generate an electric field or electric current to change a state of one or more elements in the layer of multi-stable material in the electronic paper display device.

A fifth further example provides a printer device arranged to update an electronic paper display device when temporarily connected to the printer device, the printer device comprising: a first set of contacts comprising one or more contacts arranged to connect to a first set of electrodes on a non-proximate face of the electronic paper display device through apertures through an electrophoretic ink layer in the electronic paper display device; a second set of contacts, in a same plane as the first set of contacts, and comprising one or more contacts; and drive circuitry connected to the first and second set of contacts and arranged to generate an electric field to change a state of one or more elements in the electrophoretic ink layer in the electronic paper display device.

The contacts in the second set of contacts may be electrodes and the electric field or current is generated between the first set of electrodes in the electronic paper display device and electrodes of the second set of contacts.

The second set of contacts may be arranged to connect to a second set of electrodes on a proximate face of the electronic paper display device.

The printer device of the fourth or fifth further example may further comprise a motion mechanism arranged to move the first and second sets of contacts in a non-linear motion relative to the temporarily connected electronic paper display device.

A sixth further example provides an electronic paper display device having a display face and a non-display face and the device comprising: a layer of multi-stable material; a first set of electrodes on a first face of the layer of multi-stable material, the first set of electrodes comprising one or more electrodes; and a second set of electrodes on a second face of the layer of multi-stable material, the second set of electrodes comprising one or more electrodes, and wherein all the electrodes in both the first and the second sets of electrodes are electrically contactable on a single face of the electronic paper display device.

A seventh further example provides an electronic paper display device having a display face and a non-display face and the device comprising: a layer of electrophoretic ink material; a first set of electrodes on a first face of the electrophoretic ink layer, the first set of electrodes comprising one or more electrodes; and a second set of electrodes on a second face of the electrophoretic ink layer, the second set of electrodes comprising one or more electrodes, and wherein all the electrodes in both the first and the second sets of electrodes are electrically contactable on a single face of the electronic paper display device.

The single face may be the non-display face and wherein the electrodes in the first set of electrodes are formed from an optically transparent and electrically conductive material.

The single face may be the display face and wherein the electrodes in the second set of electrodes are formed from an optically transparent and electrically conductive material.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An electronic paper display device comprising:
a layer of multi-stable material, wherein a visual appearance of the multi-stable material is controllable by application of an electric field or electric current; and
a first set of electrodes on a first face of the layer of multi-stable material, the first set of electrodes comprising one or more electrodes,
and wherein the electrodes in the first set of electrodes are electrically contactable on a single face of the electronic paper display device through the layer of multi-stable material.

2. An electronic paper display device according to claim 1, wherein the layer of multi-stable material is a layer of electrophoretic ink material.

3. An electronic paper display device according to claim 1, wherein the electrodes in the first set of electrodes are electrically contactable on a single face of the electronic paper display device through one or more apertures in the layer of multi-stable material.

4. An electronic paper display device according to claim 3, wherein the first set of electrodes comprises a single electrode and there is a single aperture through the layer of multi-stable material.

5. An electronic paper display device according to claim 3, wherein the first set of electrodes comprises a plurality of electrodes and there is one aperture through the layer of multi-stable material for each electrode in the first set of electrodes.

6. An electronic paper display device according to claim 1, further comprising:
a second set of electrodes on a second face of the layer of multi-stable material, the second set of electrodes comprising one or more electrodes,
and wherein the electrodes in both the first and the second sets of electrodes are electrically contactable on a single face of the electronic paper display device.

7. An electronic paper display device according to claim 6, further comprising:
a non-conductive masking layer covering the second set of electrodes and comprising openings which expose a portion of each of the electrodes in the second set.

8. An electronic paper display device according to claim 7, wherein the openings are smaller than the electrodes such that each electrode in the second set of electrodes is partially covered by the non-conductive masking layer and partially exposed.

9. An electronic paper display device according to claim 7, further comprising:
a plurality of routing tracks formed in a conductive layer over the non-conductive masking layer and arranged to electrically connect an electrode in the second set to a contact pad formed in the conductive layer.

10. An electronic paper display device according to claim 6, comprising a display face and a non-display face, wherein the single face is the display face and wherein the electrodes in the second set of electrodes are formed from an optically transparent and electrically conductive material.

11. An electronic paper display device according to claim 10, further comprising:
an optically transparent and non-conductive masking layer covering the second set of electrodes and comprising openings which expose a portion of each of the electrodes in the second set; and
a plurality of optically opaque and conductive regions covering each exposed portion of the electrodes in the second set.

12. An electronic paper display device according to claim 10, wherein the second set of electrodes comprises a plurality of electrodes formed from an optically transparent and electrically conductive polymer.

13. An electronic paper display device according to claim 6, wherein the second set of electrodes comprises a plurality of electrodes arranged in rows and wherein the electrodes in the first set of electrodes are electrically contactable on a single face of the electronic paper display device through a plurality of apertures in the layer of multi-stable material, one aperture being adjacent to each row of electrodes from the second set.

14. An electronic paper display device according to claim 1, comprising a display face and a non-display face, wherein the single face is the non-display face and wherein the electrodes in the first set of electrodes are formed from an optically transparent and electrically conductive material.

15. An electronic paper display device according to claim 1, arranged to provide a low resolution, large form-factor wall-mounted display.

16. A printer device arranged to update an electronic paper display device when temporarily connected to the printer device, the printer device comprising:
a first set of contacts comprising one or more contacts arranged to connect to a first set of electrodes on a non-proximate face of the electronic paper display device through apertures through a layer of multi-stable material in the electronic paper display device;
a second set of contacts, in a same plane as the first set of contacts, and comprising one or more contacts; and
drive circuits connected to the first and second set of contacts and arranged to generate an electric field or electric current to change a state of one or more elements in the layer of multi-stable material in the electronic paper display device.

17. A printer device according to claim 16, wherein the contacts in the second set of contacts are electrodes and the electric field or current is generated between the first set of electrodes in the electronic paper display device and electrodes of the second set of contacts.

18. A printer device according to claim 16, wherein the second set of contacts are arranged to connect to a second set of electrodes on a proximate face of the electronic paper display device.

19. A printer device according to claim 16, further comprising a motion mechanism arranged to move the first and second sets of contacts in a non-linear motion relative to the temporarily connected electronic paper display device.

20. An electronic paper display device having a display face and a non-display face and the device comprising:
a layer of multi-stable material;
a first set of electrodes on a first face of the layer of multi-stable material, the first set of electrodes comprising one or more electrodes; and
a second set of electrodes on a second face of the layer of multi-stable material, the second set of electrodes comprising one or more electrodes,
and wherein all the electrodes in both the first and the second sets of electrodes are electrically contactable on a single face of the electronic paper display device.
